(19) United States
(12) Patent Application Publication
(10) Pub. No.: US 2009/0230762 A1
(43) Pub. Date: Sep. 17, 2009

(54) Brake System for Motor Vehicles

(76) Inventors: Bernhard Giers, Bad Soden (DE); Georg Fachinger, Limburg/Lahn (DE); Jochen Führer, Darmstadt (DE); Thorsten Ullrich, Gernsheim (DE)

Correspondence Address: CONTINENTAL TEVES, INC., ONE CONTINENTAL DRIVE, AUBURN HILLLS, MI, 48326-1581, US

(21) Appl. No.: 12/089,749

(22) PCT Filed: Oct. 12, 2006
(86) PCT No.: PCT/EP06/67357

§ 371 Date: Apr. 10, 2008

(30) Foreign Application Priority Data
Oct. 12, 2005 (DE) 10 2005 049 298.3
Oct. 12, 2006 (DE) 10 2006 048 787.7

(51) Int. Cl. B60T 8/36

(52) U.S. Cl. 303/3

(57) ABSTRACT

Disclosed is a brake system for a motor vehicle having actuating unit (1) consisting of a brake booster (2) operable by a brake pedal (5) and actuatable independently of the driver's. A master brake cylinder (3) connected downstream of the brake booster (3), to which master brake cylinder wheel brakes (13, 14, 15, 16) of a motor vehicle are connected, an element (21) to detect a deceleration request of the driver, a hydraulic control unit (HCU) (17) for performing driving-dynamics related control operations (ABS, ESP, TCS . . . ), which is connected between the master brake cylinder (3) and the wheel brakes (13, 14, 15, 16) and includes at least one hydraulic pump (24a, b), a first electronic control unit (7) which is associated with the actuating unit (1) and serves to actuate the brake booster (2), a second electronic control unit (12) which is associated with the hydraulic control unit (HCU) (17) and serves to drive the components thereof. In order to allow cross-linking of the two electronic control units (7, 12), the first electronic control unit (7) supplies the second electronic control unit (17) with a nominal value (pₙₒₘᵢₙₐₗ) of the hydraulic pressure that can be introduced into the brake system along with a request (St) for activation of the hydraulic control unit (HCU) (17).

### BACKGROUND OF THE INVENTION

The present invention relates to a brake system for motor vehicles comprising

an actuating unit consisting of a brake booster operable by means of a brake pedal and actuatable independently of the driver's wish as well as of a master brake cylinder connected downstream of the brake booster, to which master brake cylinder wheel brakes of a motor vehicle are connected, a means to detect a deceleration request of the driver, a hydraulic control and regulation unit for performing driving-dynamics related control and regulation operations (ABS, ESP, TCS . . . ), which is connected between the master brake cylinder and the wheel brakes and includes at least one hydraulic pump, a first electronic control and regulation unit which is associated with the actuating unit and serves to actuate the brake booster, as well as a second control and regulation unit which is associated with the hydraulic control and regulation unit and serves to drive the components thereof.

A brake system of this type is disclosed in the applicant's international patent application WO 2004/005095 A1. The special feature of the prior art brake system resides in that means are provided for uncoupling a force-transmitting connection between the brake pedal and the brake booster. It is achieved by this provision that the brake system disclosed in the mentioned documents can be operated in the ‘brake-by-wire’ operating mode. In addition, a pedal travel simulator cooperating with the brake pedal is provided, which allows simulating a resetting force in the ‘brake-by-wire’ operating mode that acts on the brake pedal irrespective of an actuation of the brake booster, thereby imparting to the operator the customary pleasant brake pedal feeling. However, this mentioned publication does not give any hints to provisions which would permit carrying out a transfer of process-relevant data between the two electronic control and regulation units.

In view of the above, an object of the invention is to disclose appropriate measures that allow cross-linking the two electronic control and regulation units.

### SUMMARY OF THE INVENTION

This object is achieved by the characterizing portion of the patent claim in that the first electronic control and regulation unit includes a means supplying the second electronic control and regulation unit with a nominal value of the hydraulic pressure that can be introduced into the brake system along with a request for activation of the hydraulic control and regulation unit.

### BRIEF DESCRIPTION OF THE DRAWINGS

Further features and advantages of the invention will be explained in detail in the following description making reference to the accompanying drawings.

In the drawings:

FIG. 1 is a schematic representation of the brake system of the invention; and

FIG. 2 shows the type of communication between the electronic control and regulation units indicated in FIG. 1.

### DETAILED DESCRIPTION OF THE DRAWINGS

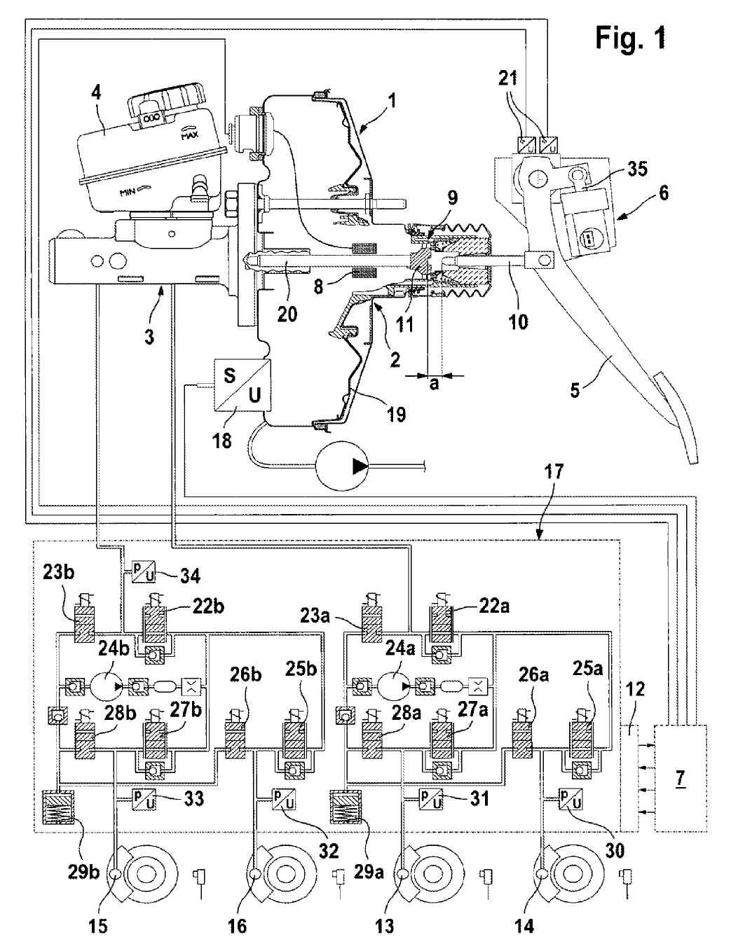

The motor vehicle brake system as illustrated in FIG. 1 of the drawing, which can preferably be operated in the ‘brake-by-wire’ operating mode, essentially consists of an actuating unit 1, a brake pedal 1, a hydraulic control and regulation unit (HCU) 17, vehicle wheel brakes 13, 14, 15, 16 connected to the hydraulic control and regulation unit (HCU) 17, a first electronic control and regulation unit 7 associated with the actuating unit 1, and a second electronic control and regulation unit 12 that is associated with the hydraulic control and regulation unit (HCU) 17. The actuating unit 1, in turn, consists of a brake booster, preferably a vacuum brake booster 2, a master brake cylinder connected downstream of the brake booster 2, preferably a tandem master cylinder 3, to the pressure chambers (not shown) of which the above-mentioned wheel brakes 13, 14, 15, 16 are connected by the intermediary of the hydraulic control and regulation unit 17, and a pressure fluid tank 4 associated with the master brake cylinder 3. A brake pedal 5 is used for actuation of the brake booster 2 by the driver, and a pedal travel simulator 6 is provided, which cooperates with the brake pedal 5 especially in the ‘brake-by-wire’ operating mode, the said simulator imparting the customary brake pedal feeling to the driver. At least one sensor device 21 is used to sense a driver's deceleration request and the actuating travel of the brake pedal 5, respectively, and the signals of the sensor device are sent to the above-mentioned first electronic control unit 7. The output signals of the first electronic control unit 7 enable, among others, actuation of an electromagnet 8 that is associated with the brake booster 2 and renders it possible to activate a pneumatic control valve 9 independently of the driver's wish, the said control valve controlling the supply of air to the brake booster 2. As will be explained in detail in the following description, the first electronic control and regulation unit 7 comprises a control circuit for controlling a characteristic quantity of the brake booster 3, preferably the travel covered by an output member 20 of the brake booster 2, and/or for controlling the hydraulic pressure that prevails in the system.

An axial slot ‘a’ provided between the end of a piston rod 10 coupled to the brake pedal 1 and a valve piston 11 of the above-mentioned control valve 9 ensures uncoupling the force-transmitting connection between the brake pedal 5 and the brake booster 2 in the ‘brake-by-wire’ operating mode. A travel sensor 18 is used to sense the travel of a movable wall 19, which generates the boosting force of the brake booster 2, or the travel of the above-mentioned output member 20 of the brake booster 2, which transmits its output force to a first piston (not shown) of the master brake cylinder 3. Furthermore, a pressure sensor 34 is integrated in the hydraulic regulation unit 17, sensing the hydraulic inlet pressure that prevails in the system.

The pedal travel simulator 6 by which, as has been mentioned above, a resetting force acting on the brake pedal 5 in the ‘brake-by-wire’ operating mode can be simulated irrespective of an actuation of the brake booster 2 is designed in such a fashion that it can be enabled in the ‘brake-by-wire’ operating mode when the force-transmitting connection between the brake pedal 5 and the brake booster 2 is uncoupled, and can be disabled outside the ‘brake-by-wire’ operating mode. The activation of the pedal travel simulator 6 is executed by means of an actuating member 35 articulated at the brake pedal 1.

In addition, it can be taken from the drawing that the hydraulic control and regulation unit (HCU) 17 includes all hydraulic and electrohydraulic components which are required to perform brake pressure control operations such as ABS, TCS, ESP . . . Among the components are per brake circuit: one separating valve 22a, b, one electric change-over valve 23a, b, one hydraulic pump 24a, b, respectively two electrically drivable pressure control valves or inlet and outlet valves 25a, b, 26a, b, 27a, b and 28a, b for the selective adjustment of the brake pressure at the wheel brakes 13 to 16, respectively one low-pressure accumulator 29a, b, and pressure sensors 30 to 33 associated with the wheel brakes 13 to 16.

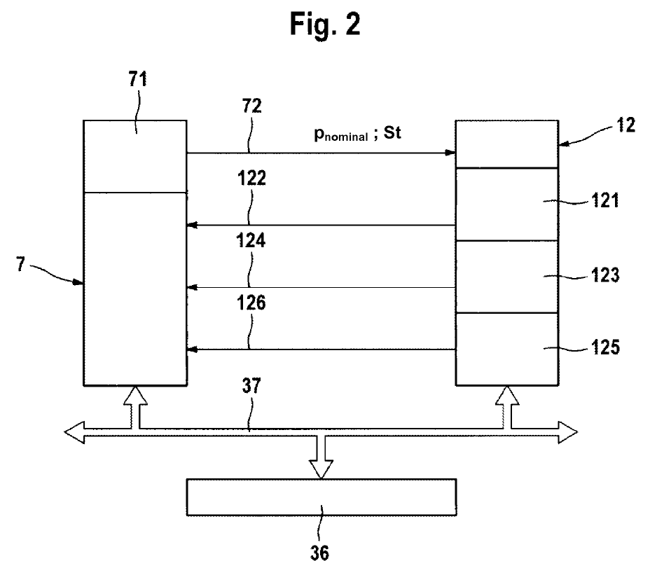

The operation of the brake booster 2 causes hydraulic pressure to build up in the master brake cylinder 3, as becomes apparent from the description referred to hereinabove. It is known, however, that in the mentioned pressure buildup the attainable maximum pressure is limited by the so-called point of maximum boosting which depends on the vacuum level available. If pressures above this point of maximum boosting are demanded, pressure is increased in the vehicle wheel brakes 13 to 16 by means of the hydraulic control and regulation unit 17, or in particular by activation of the pumps 24a, b. To safeguard a proper function of the brake system of the invention, an exchange of information and data must be permitted to take place between the first (7) and the second control and regulation unit 12. For the purpose of cross-linking the two control and regulation units 7, 12 (see FIG. 2 in particular) the first control and regulation unit 7 includes a signal transmitting device 71, which sends to the second control and regulation unit 12 a nominal value pₙₒₘᵢₙₐₗ of the pressure that is to be introduced into the wheel brakes 13 to 16 along with an activation request (St) which corresponds to the activation of the hydraulic pumps 24a, b. Criteria for the transmission of the above-mentioned nominal value pₙₒₘᵢₙₐₗ are the value of the requested pressure, which is preferably close to the hydraulic pressure that corresponds to the point of maximum boosting of the brake booster 2, or the gradient of the nominal pressure. The corresponding signal path is designated by reference numeral 72 in FIG. 2. In the event of partial failure of the actuating unit 1 or the first control and regulation unit 7, the respective unit reports the available maximum value of the pressure in the master brake cylinder 3 to the second electronic control and regulation unit 12. The second electronic control and regulation unit 12 makes use of this information in order to perform pressure increase in the wheel brakes 13 to 16 by an appropriate boosting operation. This operating mode is indicated by the first electronic control and regulation unit 7 by setting a defined value of the activation request information (St). The maximum pressure value is the pressure value around the point of maximum boosting in the embodiment shown. The production of nominal values for the pressure increase in the wheel brakes 13 to 16 is carried out in the second electronic control and regulation unit 12 based on an internally measured pressure in the master brake cylinder 3.

The second control and regulation unit 12 includes a first signal transmitting device 121, which reports to the first electronic control and regulation unit 7 the availability of the readiness for service of the hydraulic control and regulation unit 17 or the hydraulic pumps 24a, b. The report occurs via a signal path which is designated by reference numeral 122 in FIG. 2. In the event that the readiness for service of the mentioned subsystem is not available, the first electronic control and regulation unit 7 utilizes this information for fixing an appropriate fallback mode and, as the case may be, for providing a driver's alarm. In the embodiment described above, the fallback mode represents the operation of the actuating unit 1 by the muscular power of the driver assisted by vacuum, in which case only the active actuation or independent assist actuation of the brake booster 2 no longer takes place.

In addition, the second electronic control and regulation unit 12 uses a second signal transmitting device 123 to send a report about the activity and the failure of the hydraulic control and regulation unit 17 to the first electronic control and regulation unit 7 via a signal transmitting path 124, in which case the activity or the failure of driving dynamics control functions such as ABS, ESP . . . is concerned. When the brake system described is fitted in a motor vehicle equipped with a hybrid drive, the first electronic control and regulation unit 7 will adapt its strategy for including generator brake torques produced by the hybrid drive. An interface allowing a communication between the two electronic control and regulation units 7, 12 and the driving control 36 of the hybrid drive carries the reference numeral 37 in FIG. 2.

Finally, the second electronic control and regulation unit 12 includes a third signal transmitting device 125, which reports information about the current vehicle speed and the vehicle standstill to the first electronic control and regulation unit 7 by way of a signal transmitting path 126. The first electronic control and regulation unit 7 makes use of this information to optimize the control of the pressure in the master brake cylinder 3. Examples of such optimizations are represented by the limitation of the pressure and/or the pressure increase speed during standstill or at low speeds as well as an additional increase of pressure and/or the pressure increase speed at high vehicle speeds.

1-16. (canceled)

17. A brake system for a motor vehicle comprising:
an actuating unit (1) having a brake booster (2) operable by means of a brake pedal (5) and actuatable independently of a driver's wish as well as of a master brake cylinder (3) connected downstream of the brake booster (2);
master brake cylinder wheel brakes (13, 14, 15, 16) of a motor vehicle connected to the brake booster;
a detector (21) to detect a deceleration request of the driver;
a hydraulic control unit (HCU) (17) for performing driving-dynamics related control operations (ABS, ESP, TCS . . . ), which is connected between the master brake cylinder (3) and the wheel brakes (13, 14, 15, 16) and includes at least one hydraulic pump (24a, b);
a first electronic control unit (7) which is associated with the actuating unit (1) and serves to actuate the brake booster (2); and
a second electronic control unit (12) which is associated with the hydraulic control unit (HCU) (17) and serves to drive the components thereof, wherein the first electronic control unit (7) includes means (71, 72) for supplying the second electronic control unit (12) with a nominal value (pₙₒₘᵢₙₐₗ) of the hydraulic pressure that can be introduced into the brake system along with a request (St) for activation of the hydraulic control unit (HCU) (17).

18. A brake system as claimed in claim 17, wherein the nominal value (pₙₒₘᵢₙₐₗ) represents a pressure value which is higher than the pressure value that can be produced by the actuating unit (1).

19. A brake system as claimed in claim 17, wherein activation of the hydraulic control unit (HCU) (17) corresponds to actuation of the hydraulic pump (24a, b).

20. A brake system as claimed in claim 17, wherein the second electronic control unit (12) includes means (121, 122) which report the availability of the readiness for service of the hydraulic pump (24a, b) to the first electronic control unit (7).

21. A brake system as claimed in claim 20, wherein the first electronic control unit (7) utilizes the report for fixing a fallback mode and for warning the driver.

22. A brake system as claimed in claim 21, wherein the fallback mode represents operation of the actuating unit (1) by muscular power of the driver assisted by vacuum.

23. A brake system as claimed in claim 17, wherein the second electronic control unit (12) includes means (123, 124) which provide the first electronic unit (7) with a report about the activity and the failure of the components of the hydraulic control unit (HCU) (17).

24. A brake system as claimed in claim 23, wherein the first electronic control unit (7) uses the report to adapt its strategy for including generator brake torques produced by a hybrid drive of the motor vehicle.

25. A brake system as claimed in any one of claims 17, wherein the second electronic control unit (12) includes means (125, 126) which provide the first electronic control unit (7) with a report about a current vehicle speed and a vehicle standstill.

26. A brake system as claimed in claim 25, wherein the first electronic control unit (7) uses the report to optimize hydraulic pressure that is generated by the actuating unit (1).

27. A brake system as claimed in claim 26, wherein the first electronic control unit (7) limits at least on of a pressure and a pressure increase speed during standstill and at low vehicle speeds, respectively.

28. A brake system as claimed in claim 26, wherein the first electronic control unit (7) additionally augments the pressure or the pressure increase speed at high vehicle speeds.

29. A brake system as claimed in any one of claims 26, wherein the first electronic control unit (7) includes means which provide the second electronic control unit (12) with a report about the available maximum pressure in the master brake cylinder (3) upon partial failure of the actuating unit (1).

30. A brake system as claimed in claim 26, wherein the brake booster (2) is a pneumatic vacuum brake booster, and in that the maximum pressure represents the pressure value which corresponds to the proximity of the vacuum-responsive point of maximum boosting of the brake booster (2).

31. A brake system as claimed in claim 30, wherein the nominal pressure value to increase the pressure in the wheel brakes (13, 14, 15, 16) is produced in the second electronic control unit (12) based on the pressure value in the master brake cylinder (3) that is determined by the second electronic control unit (12).

32. A brake system as claimed in claim 17, wherein when the brake system is fitted in a motor vehicle equipped with a hybrid drive, signal transmission takes place between the first electronic control unit (7) and the electronic control unit (36) of the hybrid drive.
